(19) United States
(12) Patent Application Publication
(10) Pub. No.: US 2002/0009937 A1
(43) Pub. Date: Jan. 24, 2002

(54) Combinations of fibers and thermoplastic epoxy derivatives

(76) Inventors: Charles D. Dukes, Midland, MI (US); Donna G. Shaffer, Midland, MI (US); Guang-Ming Xia, Lake Jackson, TX (US); John M. Beckerdite, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/780,075

(22) Filed: Feb. 9, 2001

Related U.S. Application Data
(60) Provisional application No. 60/185,281, filed on Feb. 28, 2000.

(51) Int. Cl. B32B 27/12; B32B 5/02; B32B 27/38; D04H 1/00; B32B 27/04

(52) U.S. Cl. 442/156; 442/327; 442/149; 442/153; 442/152

(57) ABSTRACT

A composition comprising at least one fiber and a binding amount of a hydroxy-functionalized polyether or polyester and a dispersion comprising a hydroxy-functionalized polyether or polyester.

### BACKGROUND OF THE INVENTION

The present invention relates to compositions and articles that contain fibers and binders. Thermoplastic fibrous materials and binders, such as styrene-butadiene latexes, polyvinyl alcohol, and polyethylene are commonly used in the manufacture of nonwoven fabrics. These binders can give a “stiff” or “boardy” feel to the nonwoven fabric or can have an adverse effect on the absorption properties of the nonwoven fabric. For example, when nonwoven fabrics made using thermoplastic binders are incorporated into absorbent articles, the presence of the thermoplastic binder can adversely affect the performance of the fiber matrix by affecting properties such as, for example, absorption capacity and liquid wicking.

It would be desirable to have nonwoven fabrics with a “softer” hand or feel and which would not have an adverse effect on performance of the fiber matrix.

### SUMMARY OF THE INVENTION

Surprisingly, nonwoven fabrics prepared using thermoplastic hydroxy-functionalized polyethers or polyesters (hereinafter HFP's) as binders, have improved strength compared to fabrics produced without binders, without exhibiting reduced absorption performance or a “stiff” hand.

In a first aspect, the present invention is a composition comprising at least one fiber and a binding amount of a hydroxy-functionalized polyether or polyester.

In a second aspect, the present invention is a nonwoven fabric comprising the composition of the first aspect.

In a third aspect, the present invention is a dispersion or solution comprising a hydroxy-functionalized polyether or polyester.

### DETAILED DESCRIPTION OF THE INVENTION

The nonwoven fabrics of the invention are made using fibers, or other nonwoven fabric components, and hydroxy-functionalized polyethers or polyesters.

Preferably, the hydroxy-functionalized polyethers or polyesters useful in the present invention comprise at least one of the following:

(1) poly(hydroxy ethers) having repeating units represented by the formula:

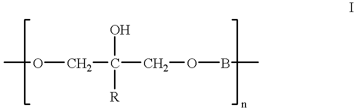

(2) poly(hydroxy amino ethers) having repeating units represented by the formula:

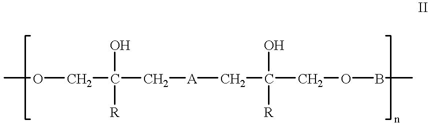

(3) poly(hydroxy ether sulfonamides) having repeating units represented by the formula:

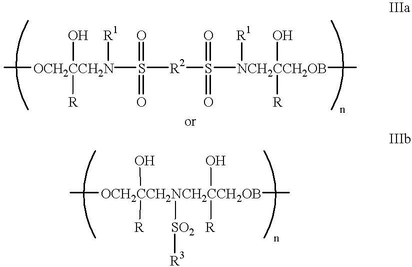

(4) poly(hydroxy ether sulfides) having repeating units represented by the formula:

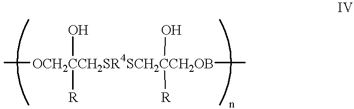

(5) poly(hydroxy amide ethers) having repeating units represented independently by any one of the formulas:

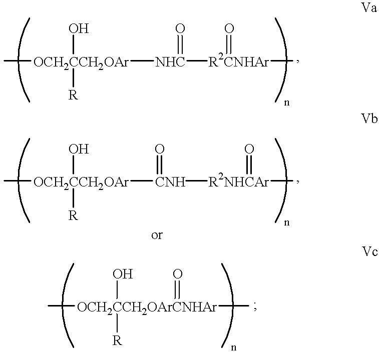

(6) poly(hydroxy amide ethers) having repeating units represented by any one of the formulas:

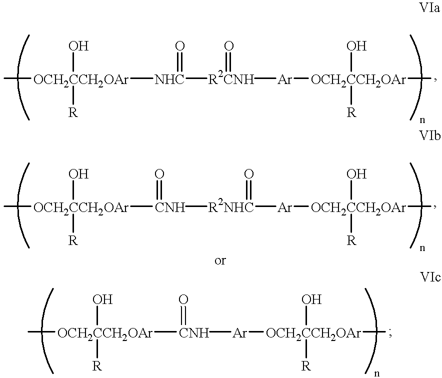

(7) poly(hydroxy ester ethers) or poly(hydroxy esters) having repeating units represented by the formula:

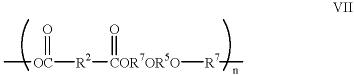

wherein R⁵ is

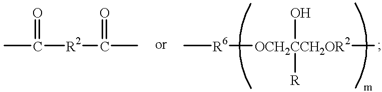

R⁶ is a divalent organic moiety which is predominately hydrocarbylene or

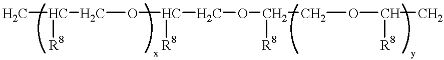

R⁷ is

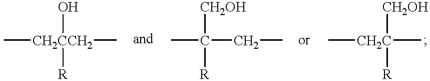

wherein R is alkyl or hydrogen; R¹ and R³ are independently a substituted or an unsubstituted alkyl or aryl moiety wherein each substituent independently is a monovalent moiety which is inert in the reactions used to prepare the hydroxy-functionalized polyethers, such as cyano, halo, amido, hydroxy and hydroxyalkyl; Ar is a divalent aromatic moiety; A is a diamino moiety or a combination of different amine moieties; B, R², and R⁴ are independently a divalent organic moiety which is predominantly hydrocarbylene; R⁸ is methyl or hydrogen; n is an integer from 5 to 1000, and m, x, and y are each independently from 0 to 100.

The term “predominantly hydrocarbylene” means a divalent radical which is predominantly hydrocarbon, but which optionally contains a minor amount of heteroatomic moiety such as oxygen, sulfur, imino, sulfonyl, and sulfoxyl.

In the preferred embodiment of the present invention, R is hydrogen; R¹ and R³ are independently methyl, ethyl, propyl, butyl, 2-hydroxyethyl or phenyl; Ar, B, R² and R⁴ are independently 1,3-phenylene, 1,4-phenylene, sulfonyldiphenylene, oxydiphenylene, thiodiphenylene or isopropylidenediphenylene; and A is 2-hydroxyethylimino, 2-hydroxypropylimino, piperazenyl or N,N′-bis(2-hydroxyethyl)-1,2-ethylenediimino. Preferably, the HFP employed in the invention is a thermoplastic HFP.

The hydroxy-functional polyethers having repeating units represented by Formula I are prepared, for example, by contacting a diglycidyl ether or a combination of diglycidyl ethers with a dihydric phenol or combination of dihydric phenols using the process described in U.S. Pat. No. 5,164,472. Alternatively, the poly(hydroxy ethers) are obtained by allowing a dihydric phenol or a combination of dihydric phenols to react with an epihalohydrin by the process described by Reinking, Barnabeo, and Hale in the Journal of Applied Polymer Science, Volume 7, page 2135 (1963). Preferably the poly(hydroxy ether of Formula I is a poly(hydroxy phenoxyether).

The polyetheramines having repeating units represented by Formula II are prepared by contacting one or more of the diglycidyl ethers of a dihydric phenol with a difunctional amine (an amine having two amine hydrogens) under conditions sufficient to cause the amine moieties to react with epoxy moieties to form a polymer backbone having amine linkages, ether linkages and pendant hydroxyl moieties. These polyetheramines are described in U.S. Pat. No. 5,275,853. The polyetheramines can also be prepared by contacting a diglycidyl ether or an epihalohydrin with a difunctional amine.

The hydroxy-functional poly(ether sulfonamides) having repeating units represented by Formulas IIIa and IIIb are prepared, for example, by polymerizing an N,N′-dialkyl or N,N′-diaryldisulfonamide with a diglycidyl ether as described in U.S. Pat. No. 5,149,768.

The hydroxy-functional polyethers having repeating units represented by Formula IV are prepared by reacting a diglycidyl ether and a dithiol as described in U.S. Pat. Nos. 4,048,141 and 4,171,420.

The poly(hydroxy amide ethers) represented by Formula V are prepared by contacting a bis(hydroxyphenylamido)alkane or arene, or a combination of 2 or more of these compounds, such as N,N′-bis(3-hydroxyphenyl)adipamide or N,N′-bis(3-hydroxyphenyl)glutaramide, with an epihalohydrin as described in U.S. Pat. No. 5,134,218.

The poly(hydroxy amide ethers) represented by Formula VI are preferably prepared by contacting an N,N′-bis(hydroxyphenylamido)alkane or arene with a diglycidyl ether as described in U.S. Pat. Nos. 5,089,588 and 5,143,998.

The compounds of Formula VII are prepared by reacting diglycidyl esters of aliphatic or aromatic diacids, such as diglycidyl terephthalate, or diglycidyl ethers of dihydric phenols with aliphatic or aromatic diacids such as adipic acid or isophthalic acid. The reaction product is usually and preferably an isomeric mixture of compounds of Formula VII in which each R⁷ is independently a hydroxy-containing group which results from ring opening of the epoxide groups of the diglycidyl ether or diglycidyl ester, which can give either a pendant hydroxyl group or a pendant hydroxymethyl group. These polyesters are described in U.S. Pat. Nos. 5,171,820 and 5,496,910. Alternatively, the poly(hydroxyester ethers) are prepared by reacting a diglycidyl ester with a bisphenol or by reacting a diglycidyl ester, diglycidyl ether, or an epihalohydrin with a dicarboxylic acid.

The hydroxy-functional polyethers available from Phenoxy Associates, Inc. are also suitable for use as the base polymer in the practice of the present invention. These polymers and the process for preparing them are described in U.S. Pat. Nos. 3,305,528 and 5,401,814.

Optionally, the hydroxy-functionalized polyether has a multimodal molecular weight distribution. The term “multimodal molecular weight distribution,” as used herein, means that the base polymer has a molecular weight distribution determined by size exclusion chromatography that contains more than one peak value. The base polymer of this invention also can be a mixture of hydroxy-functionalized polyethers of the same or different primary structures with different molecular weights.

The HFP is employed in a binding amount, i.e. an amount sufficient to bind together fibers of the nonwoven fabric so that it exhibits structural integrity. Preferably, the amount of HFP employed is from about 0.01 to about 20 weight percent based on the total weight of fibers and HFP employed. More preferably, the amount of HFP employed ranges from about 0.1 to about 10 weight percent, and most preferably is from about 0.25 to about 2 weight percent.

The HFP can be employed in a wide variety of forms. For example, the HFP can be employed in cationic form. The HFP can be employed as a thermoplastic, but it can also be employed in or converted to a number of other states. As a specific example, the HFP can be cross-linked to convert it from a thermoplastic to a thermoset material. Examples of crosslinking chemistries include silanol, maleate, fumarate, succinate, copolymerizable monomers, nonblocking fugitive cross-linkers and catalysts. (See U.S. Pat. Nos. 5,087,487; 4,814,226; 5,244,695, and 4,590,102). Additionally, the HFP can be employed as a latex which coagulates when subjected to heat. (See U.S. Pat. Nos. 5,770,528 and 4,176,108). The HFP can be employed, for example, as a latex, a solution, a dispersion, a micro-emulsion, a powder, a sheet, a microfiber, a fiber, including water soluble and water swellable fibers, or a nonwoven fabric. Mixtures of these material forms, such as a latex/solution blend, can also be employed. (See, e.g., U.S. Pat. Nos. 5,196,470 and 5,843,063). It is also possible to employ the HFP in conjunction with a conventional binder, such as a thermoplastic polymer such as polyethylene, polypropylene, poly lactic acid, polyethylene teraphthalate, PTT, polyamides, acrylics, ethylene styrene inter-polymers, thermoplastic polyurethanes and polyurethanes. The HFP can also be employed in a coacervate system.

The fibers employed in the preparation of the composition of the invention can be essentially any fibers suitable for the preparation of nonwoven fabrics. Fibers useful in the preparation of nonwoven fabrics are well known. The following types of fibers are some examples of types known in the art: fibers prepared using more than one polymer, including bicomponent fibers (e.g. U.S. Pat. Nos. 5,843,063; 5,169,580; 4,634,739; 5,921,973; 4,483,976; and 5,403,444); wettable binder fibers (U.S. Pat. No. 5,894,000); hydrophilic fibers, superabsorbent polymer fibers (U.S. Pat. Nos. 5,593,399 and 5,698,480); and the fibers listed in U.S. Pat. No. 4,176,108. The teachings of these patents, and all other patents cited herein, are hereby incorporated by reference in their entirety. Mixtures of fibers can be employed. Examples of common materials used in the manufacture of fibers include natural and synthetic materials such as, for example, polyethylene, polypropylene, polyurethane, nylon, rayon, and cotton and other cellulosic materials.

Various additives may be incorporated into the composition of the invention in order to modify certain properties thereof. Examples of additives include crosslinkers, catalysts, plasticizers, wetting agents, colorants, and other materials. (See U.S. Pat. Nos. 5,849,000 and 5,244,695).

The compositions of the invention can be prepared using techniques well known in the art including for example, dry lay, wet lay, carding, spin bonding, garnetting, and air laying processes. (See, e.g. U.S. Pat. Nos. 5,108,827, 5,487,943, 4,176,108 and 4,814,226). Nonwoven fabrics and articles can be prepared using binding techniques including, for example, hot roll, hot press, lamination, hot air bonding, calendar, spray, dip and roll transfer processes. (See, e.g., U.S. Pat. Nos. 5,824,610, 5,593,768, 5,169,580 and 5,244,695).

The compositions of the invention are useful in any application where nonwoven materials have utility. For example, nonwoven fabrics of the invention may be used in filtration applications, medical applications, clean room applications, garments, barrier products, sterilization wraps, interlinings, cushioning, stretchable absorbent materials, wipes, and in the preparation of personal-care articles, such as diapers, in the distribution, acquisition and surge layers and in the core. (See, e.g., U.S. Pat. Nos. 5,108,827, 5,893,063, 5,593,768, 5,646,077, and 5,244,695). Nonwoven products prepared with the compositions of the invention may also be useful in specialty applications such as the preparation of hygiene articles having patterned component distribution (see, e.g., U.S. Pat. Nos. 5,843,063, 5,593,399 and 5,941,862) and flushable diapers (see, e.g., U.S. Pat. No. 5,770,528).

Specific Embodiments of the Invention

The following examples and comparative experiments are given to illustrate the invention and should not be construed as limiting its scope. All parts and percentages are by weight unless otherwise indicated.

### EXAMPLES

The following materials were used in the examples. Melt index is determined with a 2.16 kg weight at 190° C.

AIRFLEX 108 A commercial EVA-based latex, a product of Air Products Company.

BLOX™ 110 A poly(hydroxy amino ether) with a melt index of 10, a product of The Dow Chemical Company.

BLOX™ 205 A poly(hydroxy amino ether) with a melt index of 5, a product of The Dow Chemical Company.

BLOX™ 220 A poly(hydroxy amino ether) with a melt index of 20, a product of The Dow Chemical Company.

RHODAPEX CO-436 An anionic surfactant available from Rhodia.

Pad Construction Method 1

This pad construction method makes a pad having a layered design on a diaper pad former designed to simulate full-scale diaper production. Fluff pulp (11.6 grams) is dispersed in an air stream. This solid/air mixture is passed across a layer of tissue supported by a perforated surface to separate the solids from the air and create a layer of fluff that is substantially uniform in thickness. After half of the fluff pulp/air mixture has been added, a granular binder is sprinkled on by hand forming an even layer. The remainder of the fluff pulp is then dispersed in an air stream. This layered composite is then wrapped in tissue and pressed for 20 seconds to a thickness of 3.18 mm between plates that are heated to the desired temperature. The dimensions of the pad are 35.5 cm by 11.0 cm by 3.18 mm.

Pad Construction Method 2—with Binder Dispersion

Preparation of Binder Dispersion

A 45 percent solution of poly(hydroxy ester ether) is prepared by dissolving the polymer in DOWANOL™ PMA, an acetate form of propylene glycol methyl ether (1-methoxy-2-propanol), a product of The Dow Chemical Company (81 g). To this is added 3 percent of a non-ionic surfactant and 0.7 percent of Rhodapex CO-436, an anionic surfactant available from Rhodia. Water is added to this solution under high shear to give a water/organic ratio of 0.35. The DOWANOL PMA is stripped under vacuum at 65° C. to yield a dispersion that is 49.3 percent water, 47 percent poly(hydroxy ester ether)(PHEE) and 3.7 percent total surfactant. The PHEE is the reaction product of adipic acid and the diglycidyl ether of bisphenol A. The dispersion has a solids content of 50.7 percent, a volume average particle size of 1.03 microns, and a total surfactant concentration of 3.7 percent.

After following Pad Construction Method 1 (leaving out the granular binder), the tissue layer is removed. The top of the pad is evenly sprayed with 9 grams of the dispersion described above. The pad is dried at 40° C. for 3 hours. Then the dry pad is split into 2 parts lengthwise. The top half is turned over and placed on top of the lower half so that the binder dispersion layer is on the inside. The tissue layer is replaced before the pad is pressed again at 100° C. for 20 seconds.

Shaping Method—Symmetrical Dog-bone

The tissue layer is removed from a pad formed by Pad Construction Method 1 or 2. Two 15 cm by 19 cm trapezoidal sections are removed from the rectangular pad so that a symmetrical dog-bone, or dumbbell, shape remains. The central section of the pad is 4 cm by 15 cm. The ends of the pad are trimmed so that the length of the pad is 33 cm.

Equipment Used for Testing

Testing is done using a coefficient of friction tester Model D 1055 manufactured by Kayeness, Inc. Honey Brook, Pa. The Ametek gauge with 2.5 g/division has a maximum reading of 450 g with a “hold at maximum” feature.

The tester has been modified so that three 11.5 cm by 12.7 cm rectangles of metal make a smooth surface (which supports the test specimen) on top of the removable sled.

Two pairs of 2.54 cm by 0.64 cm by 12.7 cm metal bars attached by 3 bolts are used to attach each end of the pad to the tester. Another bolt with a hole in the head is threaded into the lower front bar. The hook on the fixed gauge is attached to this bolt each time before measurements are made. A No. 51 C clamp attaches the other end of the pad, which is sandwiched between two of the metal bars, to the sled.

Test Procedure 1—Dry Pad Tensile Strength Testing

One set of the metal bars is attached to each end of the trimmed pad. The pad is laid lengthwise along the tester sled. The C clamp attaches one end to the sled. The sled is positioned so that the hook in the gauge fits into the hole in the bolt head of the second set of metal bars. The “hold at maximum” feature is engaged. After zeroing the gauge the instrument is turned on. The instrument pulls the clamp attached to one end of the pad lengthwise at a constant speed until the pad is torn into two pieces. After the pad is torn into 2 pieces the “hold at maximum” reading is recorded.

Test Procedure 2—Wet Strength Pad Testing

For making wet strength measurements, Testing Procedure Method 1 is modified as follows. One pair of the metal bars is attached to each end of the trimmed pad. A 14 cm by 24 cm piece of aluminum foil is laid lengthwise along the center of the sled to protect the sled from contact with the saline solution. The pad is laid lengthwise along the tester sled over the aluminum foil. The C clamp attaches one end to the sled. The sled is positioned so that the hook in the gauge fits into the hole in the bolt head of the second set of metal bars. The “hold at Maximum” feature is engaged. A 30 cc syringe is used to spread evenly 30 cc of 0.9 percent sodium chloride solution onto the 4 cm by 15 cm section of the pad. After 4 minutes the aluminum foil is gently pulled from under the pad. After zeroing the gauge the instrument is turned on. After the pad is torn into 2 pieces the “hold at maximum” reading is recorded.

### Comparative Example A and Examples 1-3

A poly(hydroxy amino ether) (PHAE) with a melt index of 20 is blended with poly(ethylene glycol), Mn 10,000, (PHAE w/10 percent PEG(10,000 Mw)), and the blend is used in the construction of pads using Pad Construction Method 1 with a press temperature of 120° C. The pads are shaped, and then tested using Testing Procedure 1. High measured values of force are desirable. The results are shown in Table 1.

TABLE 1
Amount of PHAE w/10 percent PEG
(10,000) Mw used versus Force

| | PHAE w/10% PEG | |
|---|---|---|
| Example | Amount (grams) | Force (grams) |
| Comparative | 0 | 38 |
| Example A | | |
| Example 1 | 0.0085 | 130 |
| Example 2 | 0.085 | 139 |
| Example 3 | 0.85 | 393 |

The results show that using PHAE w/10 percent PEG (10,000) Mw in increasing amounts increases the amount of force needed to tear (dry strength) the dry pad into 2 pieces. Treated pads require more breaking force than the untreated pad.

### Comparative Example B and Example 4

The binder dispersion described above is used in the construction of a composite pad using Pad Construction Method 2. The PHEE is the reaction product of adipic acid and the diglycidyl ether of bisphenol A. A control pad is constructed using Pad Construction Method 1 with a pressing temperature of 100° C. but without the use of any binder. The pads are shaped. Both pads are tested using Test Procedure 2. The results are shown in Table 2.

TABLE 2
Amount of PHEE in PHEE-latex
Dispersion used versus Force for Wet Pad Strength

| | PHEE in PHEE-latex | |
|---|---|---|
| | Dispersion | |
| Example | Amount (grams) | Force (grams) |
| Comparative Example | 0 | 67 |
| B | | |
| Example 4 | 0.85 | 167 |

The results show that it takes more force to tear the wet pad treated with the dispersion of PHEE-latex into 2 pieces than is required to tear the untreated pad into 2 pieces.

### Example 5

Solutions are made by adding poly(hydroxyaminoether) (PHAE) polymer pellets, lactic, glycolic or malic acid, (and water to the reactor. The mixture is heated to 60° C. to 65° C. with agitation and kept at this temperature until all solids are dissolved. The control is Air Products AIRFLEX™ 108 commercial latex, an EVA-based latex.

Several samples are made by spraying a piece of 60 grams pulp web that is a little larger than 4 inches by 6 inches. The PHAE solution is diluted with water to make sure that the pulp web can be saturated with the solution. After the first side of the pulp web is sprayed with about half of the solution, it was covered with a sheet coated with a tetrafluoroethylene fluorocarbon polymer and smoothed over with hand to spread out any possible uneven distribution of the droplets. The sprayed sample was heated in an oven at 200° C. for 4 minutes. The untreated side of the pulp web is sprayed with the remaining solution, smoothed and heated at 200° C. for another 4 minutes. The sample is cut (with scissors) to 4 inch by 6 inch size and weighed. The difference in weight is taken as the weight of the resin added to the wipe. Final polymer solids loading after drying is 5 percent by weight.

The tensile modulus of the samples are determined in accordance with ASTM D-638. The results are shown in Table 3.

TABLE 3

| | | Tensile | | |
|---|---|---|---|---|
| | | Modulus, psi | | |
| | | Sam- | Sam- | |
| Sample | Description | ple-1 | ple-2 | Average |
| 1 | AIRFLEX 108 | 1.5 | 1.3 | 1.4 |
| 2 | BLOX 205, 5% in 4.5% acetic acid | 5.8 | 5.7 | 5.8 |
| 3 | BLOX 110, 5% in 4.5% acetic acid | 14.2 | 5.9 | 10.1 |
| 9 | BLOX 205, 5% in 1% glycolic acid | 8.9 | 8.1 | 8.5 |
| 10 | BLOX 110, 5% in 1% glycolic acid | 11.6 | 10.9 | 11.3 |
| 11 | BLOX 220, 5% in 1% glycolic acid | 6.2 | 7.2 | 6.7 |
| 13 | BLOX 205, 5% in 4% malic acid | 14.7 | 11 | 12.9 |
| 14 | BLOX 110, 5% in 4% malic acid | 54.6 | 17.5 | 36.1 |
| 15 | BLOX 220, 5% in 4% malic acid | 12.6 | 22.2 | 17.4 |
| 18 | BLOX 220, 5% in 1.25% phosphoric | 8.5 | 17.8 | 13.2 |
| | acid | | | |

What is claimed is:

1. A composition comprising at least one fiber and a binding amount of a hydroxy-functionalized polyether or polyester.

2. The composition of claim 1 wherein the hydroxy-functionalized polyether or polyester is not in fibrous form.

3. The composition of claim 1 wherein the hydroxy-functionalized polyether or polyester is in cationic form.

4. The composition of claim 1 wherein the hydroxy-functionalized polyether or polyester is thermoplastic.

5. The composition of claim 1 wherein the fiber is in the form of a nonwoven fabric.

6. A nonwoven fabric comprising fibers and a binding amount of a hydroxy-functionalized polyether or polyester.

7. The fabric of claim 6 wherein the hydroxy-functionalized polyether or polyester is thermoplastic.

8. The fabric of claim 6 wherein the hydroxy-functionalized polyether or polyester is in cationic form.

9. A dispersion comprising a hydroxy-functionalized polyether or polyester.

10. The dispersion of claim 9 further comprising a nonionic surfactant and an anionic surfactant.

11. The dispersion of claim 10 having a solids content of 50.7 weight percent, a volume average particle size of 1.03 microns, and a total surfactant concentration of 3.7 weight percent.

12. The dispersion of claim 10 wherein the hydroxy-functionalized polyether or polyester is a poly(hydroxy amino ether).

13. The dispersion of claim 8 wherein the hydroxy-functionalized polyether or polyester is the reaction product of adipic acid and the diglycidyl ether of bisphenol A.
